(19) United States
(12) Patent Application Publication
(10) Pub. No.: US 2006/0255613 A1
(43) Pub. Date: Nov. 16, 2006

(54) STOWABLE SEAT ;SYSTEM

(75) Inventors: Larry Holmes, Oak Park, MI (US); Alan Sturt, West Bloomfield, MI (US)

Correspondence Address: ARTZ & ARTZ, P.C., 28333 TELEGRAPH RD., SUITE 250, SOUTHFIELD, MI, 48034, US

(73) Assignee: LEAR CORPORATION, Southfield, MI (US)

(21) Appl. No.: 10/908,478

(22) Filed: May 13, 2005

(51) Int. Cl. B60N 2/02

(52) U.S. Cl. 296/65.09

(57) ABSTRACT

A stowable seat system for a vehicle having a vehicle floor defining a stowage cavity formed therein includes a seat having a seat back hingably coupled to a lower seat portion. The seat back collapses onto the lower seat portion, such that the seat fits entirely within the stowage cavity when stowed. Coupled to the seat is a lift moving the lower seat portion from a stowed position within the stowage cavity to an opened position vertical with respect to the stowed position.

### TECHNICAL FIELD

The present invention relates to seating in automotive vehicles and, more particularly, to an automobile stowable seat system.

### BACKGROUND OF THE INVENTION

In vehicles, such as vans, mini-vans and sport utility vehicles, stowable passenger seating arrangements are constantly being sought for providing large, unimpeded areas for carrying cargo. It is also a constant goal to provide stowable passenger seating arrangements including comfortable seats supporting passengers at a height above the floor and approximately level with the driver. Further, passengers seated on the stowable seats should be able to enter and exit the seats when they are deployed, without having to step up and out of a seating well in the floor.

It is also a constant goal to provide cargo areas having floors that are flat when the seating is stowed for facilitating loading and carrying large sized cargo.

A number of approaches have been taken to provide this additional cargo room through including stowable seating designs. For example, one current solution includes seats detachable from the vehicle. A further example includes seats movable or foldable in a forward direction for creating additional cargo space. Generally, however, current seating designs remain bulky. Seats are not easily removed from the vehicle, and seats folding or moving forward within the vehicle still occupy precious interior space.

It is a known objective of all vehicle manufacturers to maximize the available storage area within the vehicle without significantly increasing its size. Increasing the size of the vehicle can be disadvantageous in that it can increase its cost as well as its weight and thereby decrease its fuel efficiency. It is also a known objective of these manufacturers to provide vehicles having increased seating capacity. A delicate balance must therefore be struck between increasing the storage capability of a vehicle and increasing the seating capacity of the vehicle. The present invention is directed to these ends.

### SUMMARY OF THE INVENTION

The present invention overcomes the above-stated disadvantages. In one embodiment of the present invention, a stowable seat system for a vehicle having a vehicle floor defining a stowage cavity formed therein includes a seat having a seat back hingably coupled to a lower seat portion. The seat back collapses onto the lower seat portion, such that the seat fits entirely within the stowage cavity when stowed. Coupled to the lower seat portion is a lift moving the seat from a stowed position within the stowage cavity to an opened position vertical with respect to the stowed position.

This embodiment of the present invention provides several advantages. One such advantage is that it maximizes vehicle space usage by providing seating stowable flushly with the vehicle floor.

Another advantage provided by the present invention is that that the stowable seat unstows vertically such that minimal area is required for operation of the seat.

The present invention itself, together with further objects and attendant advantages, will be best understood by reference to the following detailed description, taken in conjunction with the accompanying drawings.

### BRIEF DESCRIPTION OF THE DRAWINGS

For a more complete understanding of this invention reference should now be had to the embodiments illustrated in greater detail in the accompanying figures and described below by way of examples of the invention wherein.

FIG. 1 is a partial cutaway view of an automotive system including a stowable seat system in accordance with one embodiment of the present invention.

FIG. 2A is a partial cutaway side view of the stowed stowable seat system of FIG. 1.

FIG. 2B is a partial cutaway side view of a partially opened stowable seat system in accordance with FIG. 2A.

FIG. 2C is a partial cutaway side view of a fully opened stowable seat system in accordance with FIG. 2A.

FIG. 2d is a partial cutaway side view of a fully opened stowable seat system in accordance with FIG. 1 including a passenger sitting thereon.

FIG. 3 is a front view of the stowable seat in accordance with FIG. 1.

FIG. 4 is an operational diagram of the stowable seat system in accordance with another embodiment of the present invention.

### DETAILED DESCRIPTION

While the present invention is described primarily with respect to a stowable seat for an automotive vehicle, the present invention may be adapted to various application requiring stowable seating, as will be understood by one skilled in the art. For example, the present invention may be applied to stadium seating, airplane seating, seating for aerospace or aeronautical vehicles, or any other vehicle or structure requiring stowable seating.

In the following description, various operating parameters and components are described for a number of constructed embodiments. The specific parameters and components are included as examples and are not meant to be limiting.

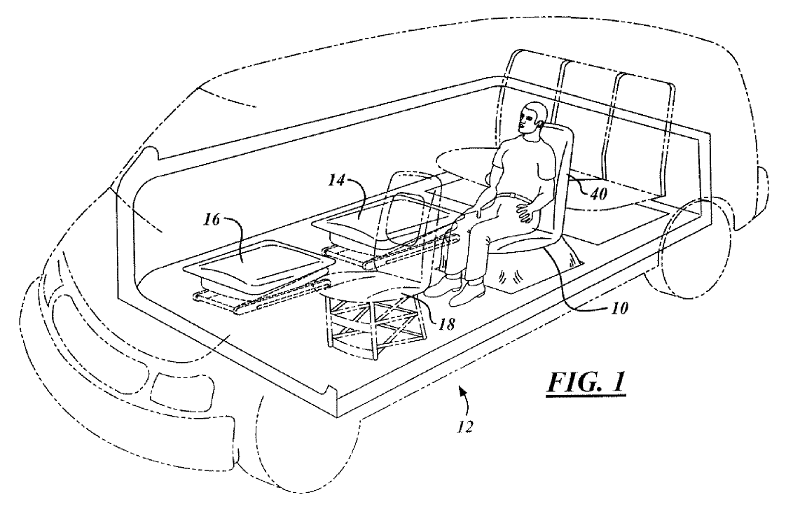

Referring to FIG. 1, a stowable seat system 10 within a vehicle 12 is illustrated in accordance with one embodiment with the present invention. The vehicle 12 also includes three other stowable seat systems (second stowable seat system 14, third stowable seat system 16, fourth stowable seat system 18), thereby illustrating that any of the vehicle seats may be stowed for providing increased floor surface area in the vehicle 12.

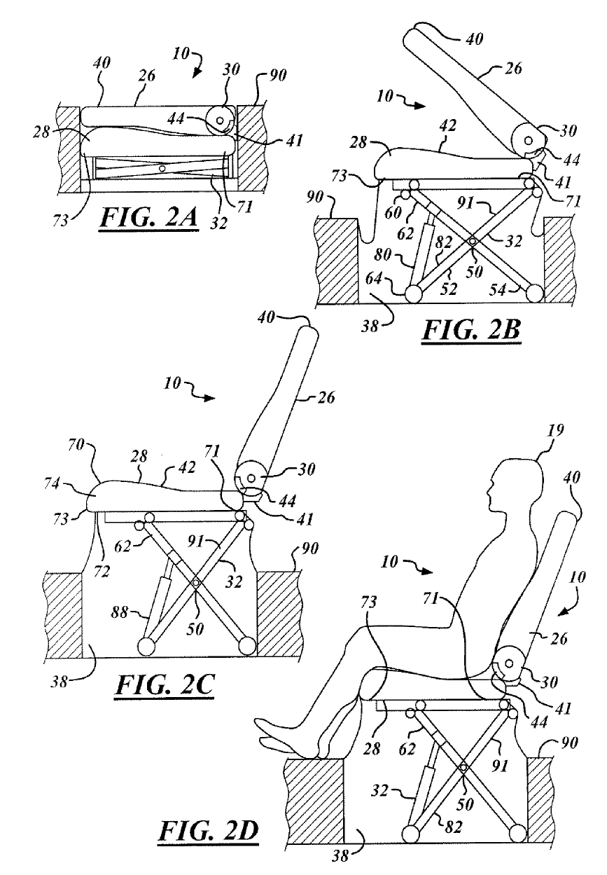

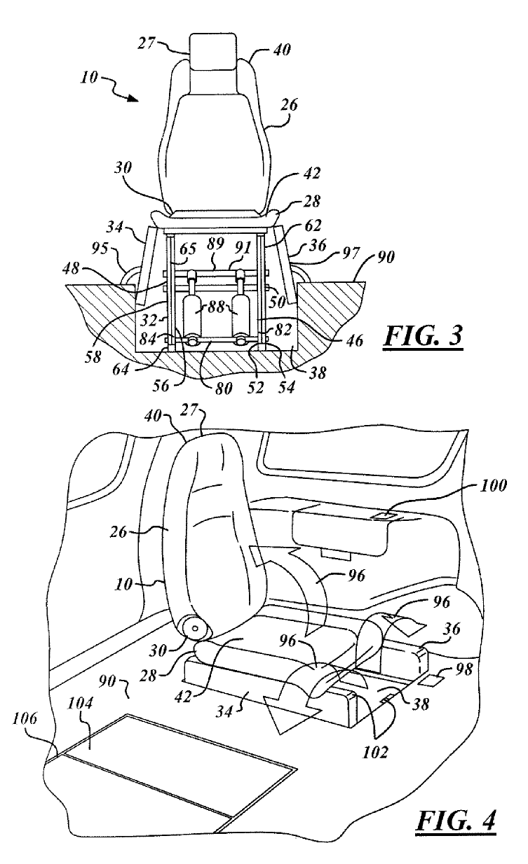

Referring to FIGS. 2A, 2B, 2C, 2d, and 3, a component view of the stowable seat system 10 of FIG. 1 is illustrated. FIG. 2A illustrates a fully stowed stowable seat system 10, FIG. 2B illustrates a partially opened stowable seat system 10, FIG. 2C illustrates a fully opened stowable seat system 10, FIG. 2d illustrates a fully opened stowable seat system 10 occupied by a vehicle passenger 19, and FIG. 3 illustrates a front view of a fully opened stowable seat system 10.

The stowable seat system 10 includes a seat 40 having a seat back 26 having an integral headrest portion 27. The seat back 26 is hingeably coupled to a lower seat portion 28 through a hinge 30. The stowable seat system 10 further includes a lift 32, moveably coupled to the lower seat portion 28 for raising and lowering the seat 40. The lower seat portion 28 is supported by floor panels 34, 36, functioning as seat supports or braces, when the seat 40 is opened and is concealed (along with the rest of the seat 40) by the floor panels when the seat 40 is stowed. That is, the stowable seat 40 folds and recedes within a stowage cavity 38, such that the floor panels 34, 36 may be closed, thereby providing a level floor 90 or storage area.

The seat 40 of the stowable seat system 10 includes the seat back 26 hingeably coupled to the lower seat portion 28. The seat back 26 and lower seat portion 28 are designed such that the lower seat portion 28 includes a receiving area 42 receiving the seat back 26, and thereby the height of the combination of these two seat components 26, 28 folded together is minimized.

The aforementioned seat components 26, 28 are hingeably coupled through the hinge 30, which may include a spring mechanism or reactive member 41 (seat actuator system) for springing the seat back 26 into its upright position when the seat 40 is opened. In an alternate embodiment, the hinge 30 includes a lock mechanism 44 coupled thereto or coupled to another portion of the seat 40. The lock mechanism 44 maintains the seat back 26 in the upright and locked position.

Coupled to the lower seat portion 28 is the lift 32 including two pairs of lifting arms 46, 48 located at opposite sides of the lower seat portion 28 or seat base and slideably coupled thereto. The sets of lifting arms 46, 48 are movably coupled together through an axial member 50. The first set of lifting arms 46 is in parallel relation to the second set of lifting arms 48 and moves relative thereto. Each set of lifting arms 46, 48 operates such that each of the lifting arms 52, 54 (of the first set 46) and 56, 58 (of the second set 48) rotate at predetermined angles relative to the axial member 50, thereby moving the seat 40 from a first position, as illustrated in FIG. 2A to a second position, as illustrated in FIG. 2B, and to a third position as illustrated in FIG. 2C. Each of the arms 52 (first of first set), 54 (second of first set), 56 (first of second set), 58 (second of second set) may include wheels 60 coupled to the upper ends 62, 65 thereof and may further include wheels 64 coupled to the lower ends 82, 84 thereof.

The lifting arms 52, 54 and 56, 58 are positioned relative to the axial member 50, such that the first arm 52 and the second arm 54 of the first set 46 cross one another in various angles relative to one another during different states of opening and stowing of the seat 40. Likewise, the first arm 56 and the second arm 58 of the second set 48 also form angles thereby, such that a first predetermined angle is formed when the seat 40 is in one stage of opening, and a second predetermined angle when the seat 40 is in a second state of opening, such as illustrated in FIGS. 2A and 2B. When the seat 40 is in a fully stowed position, the first arm 52 and second arm 54 of the first set are almost parallel to one another, and the first arm 56 and second arm 58 of the second set are also almost parallel with one another.

The lower seat portion 28 includes a top 70, a bottom 72, a bottom rear 71, a bottom front 73, and a common side 74. The top 70 is designed such that a passenger may sit thereon. The side 74 is designed with a thickness such that it may fit compactly within the stowage cavity 38. The bottom 72 includes, coupled thereto, a pair of tracks 76 such that the upper wheels 60 may move along the tracks 76. Important to note is that alternate embodiments do not include tracks and merely include the upper wheels moving along the bottom 72 of the seat 40.

The sets of lifting arms 46, 48 may also be coupled together through a first brace 80 coupled to lower portions 82, 84 of the first arm 52 of the first set and first arm 56 of the second set respectively. The brace 80 may include hydraulics, pneumatics, or spring mechanisms 88 coupled thereto and also moveably coupled to either the axial member 50, the arms 46, 48, or to a second brace 89, such that when the seat 40 is opened, the springs, pneumatics, or hydraulics 88 exert force against the first brace 80 and, for example, the second brace 89. The second brace 89 then slides along upper portions 62, 65 of the first arms 52, 56 of the first set and second set. The combination of the first brace 80, second brace 89, and springs, pneumatics, or hydraulics 88 form a lift actuator system 91.

The seat 40 collapses into the stowage cavity 38 such that when fully stowed, the floor 90 above the stowage cavity 38 appears level. When the seat 40 is opened, the first floor panel 34, and the second floor panel 36 open outwardly relative to one another and may be partially slided within the stowage cavity 38 either through a track mechanism or floor panel actuator system 95 or through manual adjustment. Once the floor panels 34, 36 are partially inserted into the stowage cavity 38, they act as supports for the lower seat portion 28, which may rest thereon. The floor panels 34, 36 and actuator system 95 collectively form a floor panel system 97.

Referring to FIG. 4, an operational view of the seat 40 is illustrated including arrows 96 demonstrating improvements of components of the seat 40. The seat 40 may be stowed or unstowed, i.e. opened, as a function of operation of a latch 98, a control panel 100, or a push-push system 102. Also illustrated in FIG. 4 is an adjacent stowed seat 102, such that the stowed seat floor panels 104, 106 are illustrated as flush relative to the floor 90. One skilled in the art will recognize that any number of stowable seats may be incorporated in the vehicle having sufficient room for the stowage cavity and seat, as discussed above.

In operation, for opening the seat, a vehicle operator activates a control device, such as pushing down on a portion of the floor panels for activating the push-push device. In response, the floor panels open and allow the seat, as discussed above, to rise vertically from the stowage cavity. The floor panels move to positions below the seat and provide support therefore. The seat rises through upward force exerted thereon by hydraulics, pneumatics, or springs on the floor lift coupled to the bottom of the seat. Opening of the seat is completed as the back of the seat flips open either automatically or through manual effort.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A stowable seat system for a vehicle having a vehicle floor defining a stowage cavity formed therein comprising:
a stowable seat comprising a seat back hingably coupled to a lower seat portion such that said seat back collapses onto said lower seat portion, said stowable seat fitting entirely within the stowage cavity when stowed; and
a lift coupled to said stowable seat, said lift moving said lower seat portion from a stowed position within the stowage cavity to an opened position vertical with respect to said stowed position.

2. The system of claim 1, wherein said lower seat portion defines a receiving area for receiving said seat back such that a combination of said seat back and lower seat portion has a minimized height.

3. The system of claim 1 further comprising:
a headrest slidably coupled to said seat back, such that said headrest slides flushly with said seat back when said seat is stowed.

4. The system of claim 1, wherein said lift comprises a first pair of intersecting lifting arms coupled to one side of a bottom of said lower seat portion, and a second pair of intersecting lifting arms coupled to an opposite side of said bottom and coupled to said first pair of intersecting lifting arms through an axial member.

5. The system of claim 4, wherein each of said first pair of intersecting lifting arms and said second pair of intersecting lifting arms rotate through a predetermined angle moving said lower seat portion from said stowed position to said opened position.

6. The system of claim 5 further comprising:
a lift actuator system comprising a first brace extending between a first one of said first pair of intersecting lifting arms and a first one of said second pair of intersecting lifting arms above intersections within said first and second pairs of intersecting lifting arms, said first brace slidably coupled to said first one of said first pair of intersecting lifting arms and said first one of said second pair of intersecting lifting arms.

7. The system of claim 6 further comprising:
a second brace and at least one extending unit rotatably coupled to said first brace and said second brace, said extending unit extending during opening of said seat extending between a second one of said first pair of intersecting lifting arms and a second one of said second pair of intersecting lifting arms below said intersection of said first pair of intersecting lifting arms and below said intersection of said second pair of intersecting lifting arms.

8. The system of claim 7, wherein said extending unit comprises at least one of a spring system, a pneumatic system, or a hydraulic system extending said extending unit.

9. The system of claim 5 further comprising:
rollers coupled to said first one of said first pair of intersecting lifting arms and said first one of said second pair of intersecting lifting arms above intersections within said first and second pairs of intersecting lifting arms such that said rollers contact said bottom of said lower seat portion and move there along as said lower seat portion moves from said stowed position within the stowage cavity to said opened position vertical with respect to said stowed position.

10. The system of claim 9 further comprising:
tracks coupled to said bottom of said lower seat portion such that said tracks guide said rollers from a front of said bottom of said lower seat portion towards a rear of said bottom of said lower seat portion.

11. The system of claim 1 further comprising:
a pair of floor panels moving from a stowed seat position lying flushly with the floor to an open position whereby said pair of floor panels brace said bottom of said lower seat portion.

12. The system of claim 11 further comprising:
floor panel actuator systems moving said floor panels from said stowed seat position lying flushly with the floor to said open position whereby said pair of floor panels brace said bottom of said lower seat portion.

13. The system of claim 12 further comprising:
a stowable seat control unit controlling at least one of said floor panel actuator systems and said lift actuator system.

14. The system of claim 13, wherein said stowable seat control unit comprises at least one of a manual switch, a manual latch, or an electronic interface.

15. The system of claim 1 further comprising:
a single floor panel moving from a stowed seat position lying flushly with the floor to an open position whereby said floor panel braces a portion of said seat.

16. A stowable seat system for a vehicle having a vehicle floor defining a stowage cavity formed therein comprising:
a stowable seat comprising a seat back and a lower seat portion hingably coupled to said seat back, said lower seat portion comprising a top, a bottom, and a common side, said seat back collapsing onto said top of said lower seat portion;
a lift coupled to said bottom of said lower seat portion, said lift comprising a first pair of intersecting lifting arms coupled to one side of said bottom, and a second pair of intersecting lifting arms coupled to an opposite side of said bottom and coupled to said first pair of intersecting lifting arms through an axial member,
each of said first pair of intersecting lifting arms and said second pair of intersecting lifting arms rotating through a predetermined angle moving said lower seat portion from a stowed position fully within the stowage cavity to an opened position vertical with respect to said stowed position;
a lift actuator system comprising a first brace, a second brace, and at least one extending unit rotatably coupled to said first brace and said second brace, said extending unit extending during opening of said seat,
said first brace extending between and slidably coupled to a first one of said first pair of intersecting lifting arms and a first one of said second pair of intersecting lifting arms above intersections within said first and second pairs of intersecting lifting arms,
said second brace extending between a second one of said first pair of intersecting lifting arms and a second one of said second pair of intersecting lifting arms below said intersection of said first pair of intersecting lifting arms and below said intersection of said second pair of intersecting lifting arms;
a pair of floor panels comprising floor panel actuator systems moving said floor panels from a stowed seat position lying flushly with the floor to an open position whereby said pair of floor panels brace said bottom of said lower seat portion; and
a stowable seat control unit controlling at least one of said floor panel actuator systems and said lift actuator system.

17. The system of claim 16 further comprising:
a headrest slidably coupled to said seat back, such that said headrest slides flushly with said seat back when said seat is stowed.

18. The system of claim 16, wherein said extending unit comprises at least one of a spring system, a pneumatic system, or a hydraulic system extending said extending unit.

19. A stowable seat system for a vehicle having a vehicle floor defining a stowage cavity formed therein comprising:
a stowable seat comprising a seat back and a lower seat portion hingably coupled to said seat back, said lower seat portion comprising a top, a bottom and a common side, whereby said seat back collapses onto said top of said lower seat portion, said stowable seat fitting entirely within the stowage cavity when stowed;
a lift moveably coupled to said bottom of said lower seat portion through rollers, said lift comprising a first pair of intersecting lifting arms and a second pair of intersecting lifting arms, said lift moving said lower seat portion from a stowed position within the stowage cavity to an opened position vertical with respect to said stowed position through spring leverage applied to each of said first pair of intersecting lifting arms and each of said second pair of intersecting lifting arms,
said rollers contacting said bottom of said lower seat portion and moving there along as said lower seat portion moves from said stowed position within the stowage cavity to said opened position vertical with respect to said stowed position;
a floor panel system comprising a floor panel actuator system moving floor panels from a stowed seat position lying flushly with the floor to an open position whereby said floor panels brace said bottom of said lower seat portion; and
a control device operating said floor panel system.

20. The system of claim 19, wherein said control device comprises at least one of a control panel, a lever, or a push-push system.
